(19) United States
(12) Patent Application Publication
(10) Pub. No.: US 2026/0303663 A1
(43) Pub. Date: Oct. 1, 2026

(54) SYSTEM AND METHOD FOR INTELLIGENCE ADMINISTRATION CONTROLLER POLICIES FOR IMAGE TRUST

(71) Applicant: Wiz, Inc., New York, NY (US)

(72) Inventors: Omri SHOHAM, New York, NY (US); Amir LANDE BLAU, Tel Aviv (IL); Ofir COHEN, Tel Aviv (IL)

(73) Assignee: Wiz, Inc., New York, NY (US)

(21) Appl. No.: 19/092,783

(22) Filed: Mar. 27, 2025

(51) Int. Cl. H04L 9/40; G06F 8/61; H04L 67/00

(52) U.S. Cl. CPC H04L 63/20; G06F 8/63; H04L 67/34

(57) ABSTRACT

A system and method for enforcing a cybersecurity policy through multiple different enforcement points in a cloud computing environment is presented. The method includes generating a validation database, the validation database including a plurality of validated software images and a corresponding method of validation; configuring an enforcement point of a first type to validate a first deployable software image based on a first policy; configuring an enforcement point of a second type to validate a second deployable software image based on the first policy; and authorizing deployment of a software image in the cloud computing environment in response to determining that the enforcement points permit deployment.

### TECHNICAL FIELD

The present disclosure relates generally to the field of cybersecurity and specifically to the utilization of enforcement points to enforce security policies across the computing environment.

### BACKGROUND

Nearly all activities today rely at some point or another on a computer-based solution. Organizations rely on computing environments for communication, control, storage of information, accounting, customer relations, and so many others.

Different computing environments provide different advantages over one another. Organizations may have further objectives when selecting a computing environment, such as security, privacy, regulations, etc. The offerings today are many and tailored, and can include on-premises environments, networked environments, cloud computing environments, hybrid environments, and the like.

Even within these environments, a cloud computing environment can include multiple differentiated environments, such as a staging environment, a production environment, a testing environment, and the like.

Often, an organization has security policies in place, to determine what principals (e.g., user accounts, service accounts, etc.) can access what types of resources of the computing environment. However, maintaining such policies is complicated, as each of the different environments requires its own solution. This leads to complications in the management of cybersecurity policies, which can, in turn, lead to exposures in an organization’s computing infrastructure.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include generating a validation database, the validation database including a plurality of validated software images and a corresponding method of validation. The method may also include configuring an enforcement point of a first type to validate a first deployable software image based on a first policy. The method may furthermore include configuring an enforcement point of a second type to validate a second deployable software image based on the first policy. The method may in addition include authorizing deployment of a software image in the cloud computing environment in response to determining that the enforcement points permit deployment. Other embodiments of this aspect include corresponding computer systems, apparatus, and computer programs recorded on one or more computer storage devices, each configured to perform the actions of the methods.

Implementations may include one or more of the following features. The method may include: accessing a plurality of software images in a repository, where a repository is configured to store software images. The method may include: configuring the validation database to store a software bill of materials (SBOM) based on a predetermined data schema. The method may include: validating the software image based on comparing an initial hash value associated with the software image to a recalculated hash value of the software image. The method where a first type of enforcement point may include: an admission controller, where the admission controller is configured to request the first policy from a policy engine. The method may include: configuring the policy engine to generate any one of: a first policy, a policy, a predefined policy, a rule, a conditional rule, and any combination thereof. The method where a second type of enforcement point includes any one of: a sensor, a process of a Continuous Integration and Continuous Deployment (CI/CD) pipeline, a disk, and any combination thereof. The method may include: configuring the sensor to detect events related to any one of: a software image, a software application, a software process, a software component, and any combination thereof, deployed in a resource on which the sensor is deployed. The method may include: configuring the enforcement point of the first type and the enforcement point of the second type to deny the deployment of the software image in response to the software image not being validated based on a policy. Implementations of the described techniques may include hardware, a method or process, or a computer tangible medium.

In one general aspect, a non-transitory computer-readable medium may include one or more instructions that, when executed by one or more processors of a device, cause the device to: generate a validation database, the validation database including a plurality of validated software images and a corresponding method of validation; configure an enforcement point of a first type to validate a first deployable software image based on a first policy; configure an enforcement point of a second type to validate a second deployable software image based on the first policy; and authorize deployment of a software image in the cloud computing environment in response to determining that the enforcement points permit deployment. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: generate a validation database, the validation database including a plurality of validated software images and a corresponding method of validation. The system may in addition configure an enforcement point of a first type to validate a first deployable software image based on a first policy. The system may moreover configure an enforcement point of a second type to validate a second deployable software image based on the first policy. The system may also authorize deployment of a software image in the cloud computing environment in response to determining that the enforcement points permit deployment. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: access a plurality of software images in a repository, where a repository is configured to store software images. The system where the memory contains further instructions which when executed by the processing circuitry further configure the system to: configure the validation database to store a software bill of materials (SBOM) based on a predetermined data schema. The system where the memory contains further instructions which when executed by the processing circuitry further configure the system to: validate the software image based on comparing an initial hash value associated with the software image to a recalculated hash value of the software image. The system where a first type of enforcement point may include: an admission controller, where the admission controller is configured to request the first policy from a policy engine. The system where the memory contains further instructions which when executed by the processing circuitry further configure the system to: configure the policy engine to generate any one of: a first policy, a policy, a predefined policy, a rule, a conditional rule, and any combination thereof. The system where a second type of enforcement point includes any one of: a sensor, a process of a Continuous Integration and Continuous Deployment (CI/CD) pipeline, a disk, and any combination thereof. The system where the memory contains further instructions which when executed by the processing circuitry further configure the system to: configure the sensor to detect events related to any one of: a software image, a software application, a software process, a software component, and any combination thereof, deployed in a resource on which the sensor is deployed. The system where the memory contains further instructions which when executed by the processing circuitry further configure the system to: configure the enforcement point of the first type and the enforcement point of the second type to deny the deployment of the software image in response to the software image not being validated based on a policy. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example of a schematic diagram of a cloud computing environment, utilized to enforce a single policy access, implemented in accordance with an embodiment.

FIG. 2 is an example of a schematic of a software container cluster having an admission controller for policy implementation, utilized to describe an embodiment.

FIG. 3 is an example schematic illustration of a sensor backend communicating with a plurality of sensors deployed on various workloads, implemented in accordance with an embodiment.

FIG. 4 is an example flowchart of a method for enforcing a cybersecurity policy through multiple difference enforcement points in a cloud computing environment, implemented in accordance with an embodiment.

FIG. 5 is an example schematic diagram of an inspector, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for intelligence administration controller policies for image trust. In an embodiment, a computing environment is a network of computers, a cloud computing environment, an on-prem environment, a hybrid computing environment, a combination thereof, and the like. Applying a single policy to multiple computing environments is advantageous, as an organization which utilizes multiple computing environments is therefore required to maintain a single point containing policies for the entire organization, regardless of a specific computing environment in use.

This is especially useful, for example, where an organization utilizes multiple computing environments such as a staging environment, a testing environment, an infrastructure as code environment, any combination thereof, and the like. In some embodiments, an organization further utilizes such environments across different cloud computing infrastructures, e.g., Amazon® Web Services (AWS), Google® Cloud Platform (GCP), Microsoft® Azure, and the like. Thus, an organization utilizes a first environment (e.g., first staging environment) in a first cloud computing infrastructure (e.g., AWS), and a second environment (e.g., second staging environment) in a second cloud computing infrastructure (e.g., GCP). Utilizing a unified policy engine allows reduced storage, as there is no need to retain multiple copies of policies in different computing environments, and reduces the need to ascertain that all computing environments of an organization utilize the same policies across all computing environments, according to an embodiment.

For example, the first environment and the second environment would each require a policy engine, each policy engine having copies of policies stored on the other. Therefore, where a change, such as an exception, is introduced to a policy in the first environment, a corresponding change would have to be introduced to a corresponding policy in the second environment.

It is further advantageous to apply a single policy to multiple points of enforcement. As will be discussed in more detail below, a computing environment such as a cloud computing environment, includes multiple points of enforcement, such as CI/CD, sensors, admission controllers, etc.

In this regard, it is recognized that applying a policy and changing policies are activities that can be performed by a human. However, cybersecurity policies, in order to be effective, need to be applied in a manner which is consistent, objective, and equal across multiple computing environments and in a timely manner as any time window where policies are not aligned between computing environments potentially results in an exposure of that environment.

A human, therefore, is incapable of applying policies, and applying changes to policies, across multiple computing environments, or indeed any computing environments, in a manner which is timely, consistent, objective, and equal. This is because the human mind inherently applies conditions subjectively, whereas the disclosed system utilizes an objective admission controller.

According to an embodiment, a software container cluster includes an admission controller which is configured to receive a policy from a unified policy engine, and apply the policy to all containers, nodes, pods, combinations thereof, and the like, deployed in a software container cluster.

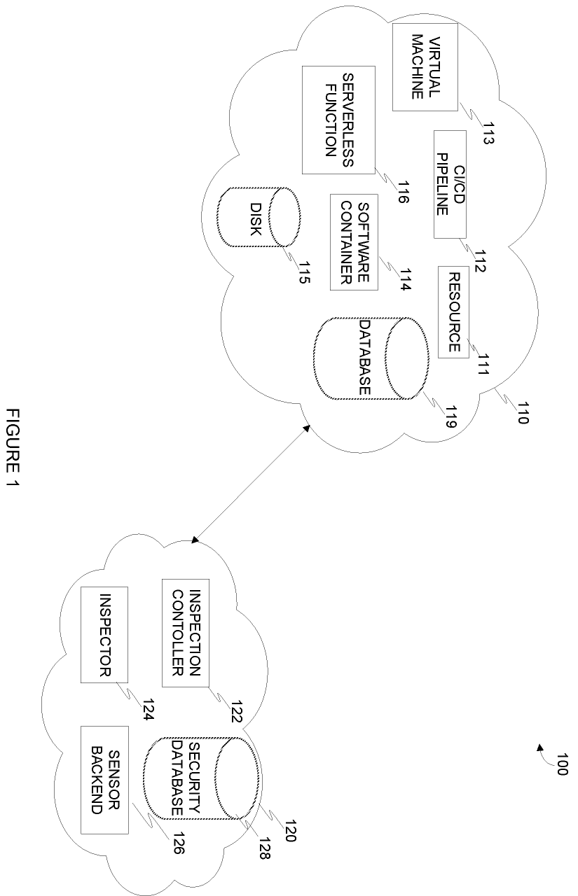

FIG. 1 is an example schematic diagram 100 of a cloud computing environment utilized to enforce a single policy , implemented in accordance with an embodiment. In an embodiment, a cloud computing environment includes a virtual private cloud (VPC), Virtual Network (VNet), and the like, and is deployed over a cloud computing platform. A cloud computing platform may be provided, for example, by Amazon® Web Services (AWS), Google® Cloud Platform (GCP), Microsoft® Azure, and the like.

In an embodiment, a cloud computing environment includes a workload 110. In various embodiments, a workload 110 includes cloud entities deployed as components of the workload 110. In an embodiment, a cloud entity is a principal, a resource 111, and the like. In an embodiment, a resource 111 is a cloud entity that provides access to a compute resource, such as a processor, a memory, a storage, and the like.

In some embodiments, a cloud entity includes a virtual machine 113, a software container 114, a serverless function 116, a Continuous Integration and Continuous deployment (CI/CD) pipeline 112, a database 119, and the like. In certain embodiments, a resource is a software application, such as a web server, a gateway, a load balancer, a web application firewall (WAF), an appliance, and the like.

In an embodiment, a resource is an application, a software component, a file, and the like deployed in the computing environment 110. According to an embodiment, virtual machine 113 is deployed, for example, utilizing Oracle® VirtualBox®. In an embodiment, the serverless function 116 is utilized with Amazon® Lambda.

In some embodiments, a software container 114 is a unit of software that packages software code objects and their dependencies for applications to run in the computing environment 110. In various embodiments, a CI/CD pipeline 112 is a series of processes utilized to deliver updated software versions for resources, applications, and the like, in the cloud computing environment. Some of the CI/CD pipeline 112 processes include deploying the software code, testing the software code, compiling the software code, a combination thereof, and the like.

In some embodiments, the processes of a CI/CD pipeline 112 are configured to be utilized as an enforcement point for a cybersecurity policy. In certain embodiments, the CI/CD pipeline 112 is an automated workflow that encompasses steps for continuous integration, continuous delivery, and deployment. In various embodiments, the CI/CD pipeline 112 is a plurality of automated processes that streamlines the software deployment process in the computing environment. In an embodiment, a process of the CI/CD pipeline 112 is configured to generate a software image, a software file, a software component, and the like.

In various embodiments, the validation database 119 is configured to store a Software Bill of Materials (SBOM) of software components deployed in the computing environment 110. In some embodiments, the validation database 119 is configured to store data pertaining to deployed resources (e.g., applications, servers, etc.), known software images, software components, code objects, files, a combination thereof, and the like, in the computing environment 110. In certain embodiments, a software image includes a Docker® image, a container image, a virtual machine image, a disk image, and the like.

In an embodiment, an SBOM is an inventory that includes a plurality of identifiers, each identifier corresponding to a software component deployed in the cloud computing environment. In some embodiments, the plurality of identifiers are stored in a standard format, such as SPDX, CycloneDX, CPE, and the like. In certain embodiments, the standard format is expressed in a JSON data schema, XML data schema, a protocol buffer, combinations thereof, and the like. In an embodiment, the validation database 119 includes a plurality of code objects, software images, and the like, which are validated objects, validated images, etc. In some embodiments, image validation, for example, is performed based on a hash value, a checksum, a certificate, a cryptographic key, and the like, which is received from a publisher, code repository, and the like, which has stored thereon the valid image.

In various embodiments, the computing environment 110 is monitored by an inspection environment 120. In some embodiments, the computing environment 110 is monitored for cybersecurity threats by the inspection environment 120. In certain embodiments, the inspection environment 120 is implemented as a cloud computing environment, including a VPC, VNet, and the like. In an embodiment, the inspection environment 120 includes an inspector 124, an inspection controller 122, a sensor backend server 126, and the like.

In some embodiments, the inspection controller 122 is configured to allocate inspection workloads based on an inspection plan to continuously, periodically, etc., monitor the computing environment 110 for threats, vulnerabilities, and the like. In some embodiments, the inspector 124 is configured to detect cybersecurity objects in the computing environment 110, for example, by generating inspectable disks and inspecting the inspectable disks for the cybersecurity objects. In an embodiment, the inspector 124 is configured to store detections of threats, vulnerabilities, and the like, in a security database 128. In an embodiment, the security database 128 is configured to store a representation of the computing environment 110, of a resource 11, a disk 115, a detection, an enrichment, a combination thereof, and the like.

In an embodiment, a sensor backend server 126 is a workload, such as a virtual machine, software container, serverless function, combination thereof, and the like, which is deployed in the inspection environment 120. In various embodiments, the sensor backend server 126 is configured to receive sensor data which is generated from a sensor (not shown), deployed on resources in the computing environment 110.

For example, the sensor backend server 126 is configured, in an embodiment, to receive events from a sensor. In some embodiments, the sensor is configured to request from the sensor backend 126, rules, definitions, and the like, which the sensor is configured to apply to events. For example, in an embodiment, events are detected on an eBPF interface. For example, in an embodiment, a predetermined event, such as indicating access to an IP address, IP address range, and the like, is checked against a definition. A definition is a logical expression which, when applied to an event, yields a “true” or “false” result, in an embodiment. In an embodiment, a rule is a logical expression which includes an action. For example, in an embodiment, a rule is that in response to a certain definition being true when applied to an event, data pertaining to the event should be sent to the sensor backend server 126.

In some embodiments, the sensor backend server 126 is configured to initiate inspection of a resource deployed in the cloud computing environment 110. For example, in an embodiment, the sensor backend server 126 is configured to initiate such inspection in response to receiving an event, data, a combination thereof, and the like, from a sensor deployed on a resource. In an embodiment, initiating inspection of a resource is performed by generating an instruction for an inspection controller 122, the instruction, when executed, allocates an inspector 124 to inspect the resource.

In various embodiments, the inspector 124 is configured to access resources 111, applications software code, code objects, software data, software files, binaries, libraries, software images, and the like, from a disk 115. In some embodiments, the inspector 114 is configured to initiate static analysis on the software applications, code objects, software data, software files, and the like, stored on the disk 115. In an embodiment, the inspector 124 is configured to inspect for a cybersecurity object. A cybersecurity object may be, for example, a password, a certificate, a cryptographic key, a software, an application, a library, a binary, a configuration file, a filesystem, a combination thereof, and the like.

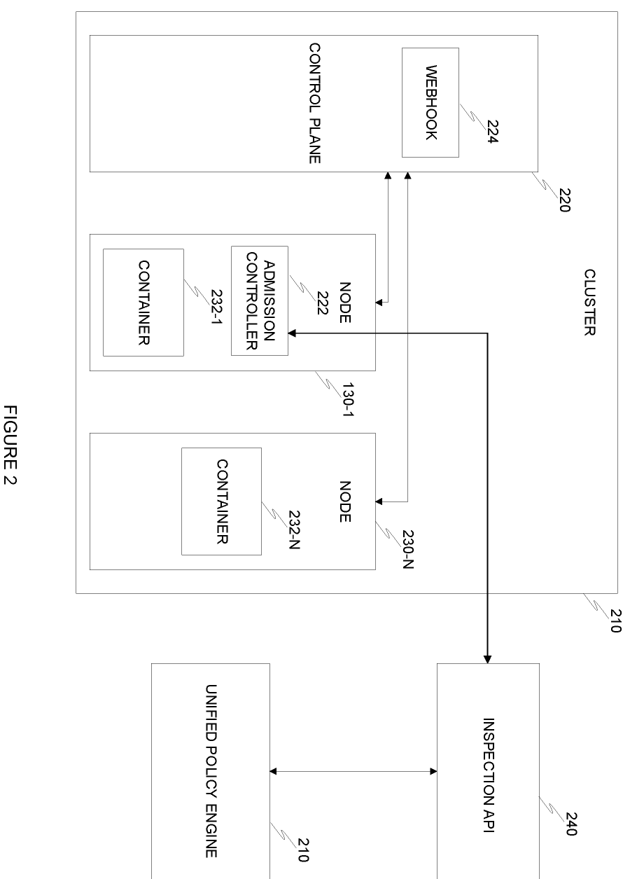

FIG. 2 is an example of a schematic of a software container cluster having an admission controller for policy implementation, utilized to describe an embodiment. In an embodiment, a container cluster 210 is deployed on a computer system.

In some embodiments, a software container cluster 210 is implemented utilizing a Kubernetes® platform, a Docker® Engine, and the like. In certain embodiments, a software container cluster 210 is configured to deploy a plurality of software containers. In an embodiment, a software container is a containerized software application.

In certain embodiments, a container cluster 210 includes a control plane 220 configured to communicate with an inspection application programming interface (API) 240, and a plurality of nodes 230-1 through 230-N, where ‘N’ is an integer having a value of ‘2’ or greater, individually referred to as node 230 and collectively referred to as nodes 230.

In an embodiment, the control plane 220 is implemented on a single machine in the cluster. In some embodiments, the machine on which the control plane 220 is implemented only executes components of the control plane 220. For example, in an embodiment, the machine does not include a container based on a user-generated image, base image, and the like.

For example, in some embodiments, a Kubernetes container cluster control plane 220 includes components such as an API server, a key value store, a scheduler, a controller, and the like. In an embodiment, the API server is implemented as a kube-apiserver, which is configured to expose the Kubernetes API to external resources. In certain embodiments, the key value store is configured to store key values, cluster data, and the like.

In some embodiments, the controller includes a node controller, a job controller, a service account controller, and the like. In certain embodiments, the control plane 220 includes a webhook 224. In an embodiment, the webhook 224 is a validating webhook, a mutating webhook, and the like. In an embodiment, a webhook 224 is configured to detect a request to an API, to another node in the cluster, and the like. In certain embodiments, the webhook 224 is further configured to send the request to an admission controller 222.

In an embodiment, the cluster 210 includes a plurality of nodes 230-1 through 230-N. In certain embodiments, each node 230 includes a container 232. In some embodiments, the container 232 includes a containerized software application. In certain embodiments, a node 230 includes a plurality of containers, an agent, a network proxy, a combination thereof, and the like. In an embodiment, a containerized software application includes a software, dependencies of the software, a combination thereof, and the like.

In certain embodiments, an inspection API 240 is configured to expose resources, communication, and the like, with a cloud computing environment. For example, in an embodiment, a cloud computing environment is a virtual private cloud (VPC), a virtual network (VNet), and the like, deployed on a cloud computing infrastructure. In an embodiment, a cloud computing infrastructure is Amazon® Web Services (AWS), Google® Cloud Platform (GCP), Microsoft® Azure, and the like. In certain embodiments, the control plane 220 of the cluster 210 is configured to communicate through the inspection API 240.

In some embodiments, an admission controller 222 is deployed on a node 230-1. In an embodiment, an admission controller 222 is configured to receive intercepted requests to the API server of the control plane 220. For example, in an embodiment, a software container 232-N is configured to communicate through a node 230-N to an API server of the control plane 220, which in turn is configured to communicate with the inspection API 240.

In certain embodiments, the admission controller 222 is implemented as computer software deployed on a node of the cluster 210. In some embodiments, the admission controller 222 is configured to communicate with a unified policy engine 210, for example through the inspection API 240.

In some embodiments, the admission controller 222 is configured to request a policy from the unified policy engine 210. In an embodiment, the admission controller 222 is configured to apply the received policy on a request intercepted from a container 232-1 of a node 230-1.

In some embodiments, a policy includes a conditional rule. For example, in an embodiment, a policy includes a conditional rule, utilized to check if a network communication is directed to an IP address which is on a list of banned IP addresses. In an embodiment, a request is generated by a software container 232-N to send a network message, the request including a destination address (e.g., an IP address). In an embodiment, the request is delivered from the node 230-N to the control plane 220, where the request is intercepted by the webhook 224. The request is sent to the admission controller 222, which is configured to apply a policy on the request.

In some embodiments, the admission controller 222 is configured to apply a policy to the request. For example, in an embodiment, the admission controller 222 is configured to apply a conditional rule such that if a communication is directed to an IP address stored in a list of blocked IP addresses, the communication is denied, and the request is not passed to the inspection API 240. In certain embodiments, the admission controller 222 is configured to apply a conditional rule such that if a communication is not directed to an IP address stored in a list of blocked IP addresses, the communication is allowed to pass through and is forwarded, for example, to the inspection API 240.

In an embodiment, the admission controller 222 is configured to apply a conditional rule such that if a communication is directed to an IP address stored in a list of allowed IP addresses, the communication is allowed, and the request is passed to the inspection API 240. In some embodiments, the admission controller 222 is configured to apply a conditional rule such that if a communication is not directed to an IP address stored in a list of allowed IP addresses, the communication is denied, and the request is not passed to the inspection API 240.

In an embodiment, the admission controller 222 is configured to apply a validation, for example from a validation database 119. For example, according to an embodiment, the admission controller 222 is configured to detect a request to deploy a container based on an image. In an embodiment, the admission controller 222 is configured to request a validation, validation token, validation value (e.g., a hash value, a checksum value, etc.), a fingerprint, a combination thereof, and the like, from a validation database 119.

In some embodiments, applying a validation includes validating an image, a code, and the like, based on a validation received from a validation database 119. In an embodiment, where the admission controller 222 successfully validates an image, a software container, such as container 232-1, is deployed.

FIG. 2 is an example of a network diagram with multiple computing environments utilizing a unified policy engine, implemented according to an embodiment. In an embodiment, a unified policy engine 210 includes a rule, a policy, a combination thereof, and the like. In some embodiments, a rule includes a condition, for example, such that when the condition is met an action is performed, when the condition is met an action is refrained from being performed, when a condition is not met an action is performed, when a condition is not met an action is refrained from being performed, combinations thereof, and the like.

In some embodiments, a unified policy engine 210 supplies rules, policies, and the like, to various computing environments. For example, in an embodiment, the unified policy engine supplies a rule to a first cloud computing environment 220, a second cloud computing environment 230, and an infrastructure as code (IaC) environment 240.

In an embodiment, a cloud computing environment is a virtual private cloud (VPC), a virtual network (VNET), and the like, implemented on a cloud computing infrastructure. According to an embodiment, a cloud computing infrastructure is, for example, Amazon® Web Services (AWS), Microsoft® Azure, Google® Cloud Platform (GCP), and the like.

In certain embodiments, an IaC environment 240 is utilized, for example, with Terraform®, Ansible®, Chef®, Puppet®, and the like.

In certain embodiments, security policies are maintained for different compute environments, for example, in order to secure certain digital assets, prevent unwanted or unintended access, and the like. In some embodiments, for example, where continuous integration and continuous deployment (CI/CD) is implemented, multiple compute environments are related. For example, according to an embodiment, declaratory code in an IaC environment 240 is utilized to deploy a software container cluster 222 in a staging environment 220.

In an embodiment, a staging environment is a cloud computing environment in which resources, principals, and the like, are deployed prior to being deployed in a production environment, such as production environment 230. This is beneficial as it allows to test and benchmark a resource, such as the container cluster 222 prior to deploying a counterpart to the container cluster 222 in the production environment 230. For example, in an embodiment, the counterpart to the container cluster 222 deployed in the staging environment 220 is the software container cluster 232 deployed in the production environment 230.

According to an embodiment, once a resource, such as the container cluster 222 passes a benchmark, test, and the like, code utilized to deploy the container cluster 222 in the staging environment 220 can be utilized to deploy the container luster 232 in the production environment 230. In some embodiments, it is beneficial to take action based on a code object, a resource deployed in a staging environment based on the code object, and a corresponding resource deployed in the production environment, wherein the action applies to each of the code object and two resources.

For example, in some embodiments, it is useful to employ a policy on a code object, on a resource deployed in a staging environment 220, and a corresponding resource deployed in a production environment 230, as all these correspond to each other. In certain embodiments, a policy is enacted based on observation of a resource, such as the container cluster 222, in a staging environment.

Utilizing a unified policy engine 210 allows to store a single policy utilized by each related computing environment. This is preferable to storing a corresponding policy in each computing environment, especially when these computing environments are related to each other. In an embodiment, utilizing a single unified policy engine 210 also reduces storage space required to store redundant similar policies, as it eliminates the need to store a corresponding policy in each different (yet related) computing environment.

Furthermore, configuring a software container cluster to deploy an admission controller which is configured to utilize policies from the unified policy engine 210 provides a level of assurance that a policy is enacted on each container in the cluster, and across multiple clusters in any computing environment. A single policy is therefore applied equally, objectively, and consistently. While it is recognized, for example, that a human can apply a condition to a resource, it is also recognized that a human is incapable of applying a condition (e.g., a policy) in a manner that is equal and objective in a consistent manner across multiple computing environments, and can certainly not do so within a timeframe that would make application of such a policy useful.

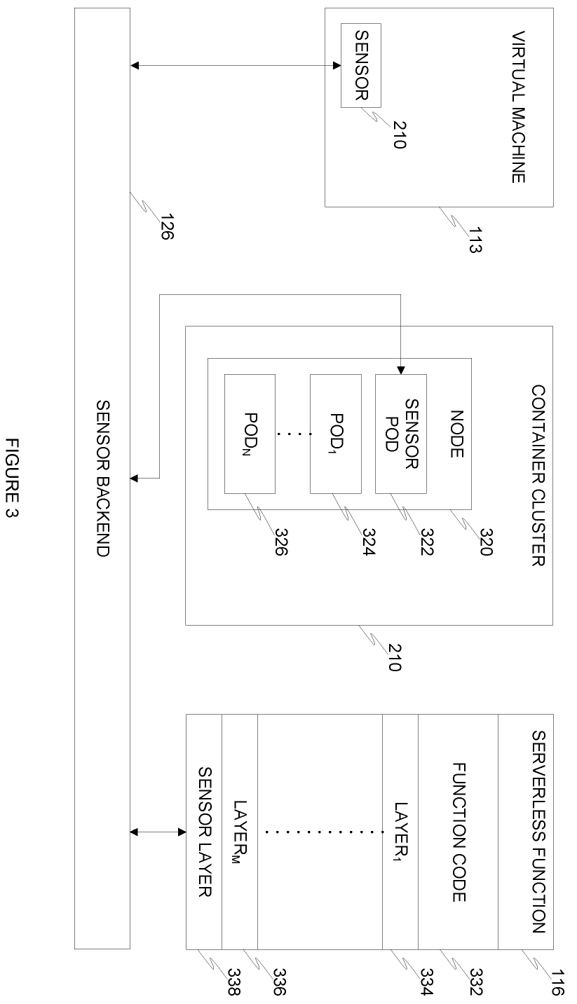

FIG. 3 is an example schematic illustration of a sensor backend communicating with a plurality of sensors deployed on various workloads, implemented in accordance with an embodiment. In some embodiments, a sensor backend 126 is configured to communicate with a machine (not shown) having a sensor installed thereon and communicatively coupled with the sensor backend 126. In an embodiment, the machine is a bare metal machine, a computer device, a networked computer device, a laptop, a tablet, and the like.

In an embodiment, a sensor backend 126 is implemented as a virtual machine, a software container, a serverless function, a combination thereof, and the like. In certain embodiments, a plurality of sensor backends 126 may be implemented. In some embodiments where a plurality of sensor backends 126 are utilized, a first group of sensor backend servers of the plurality of sensor backend servers is configured to communicate with a sensor deployed on a first type of resource (e.g., virtual machine), a second group of sensor backend servers is configured to communicate with resources of a second type, etc.

In an embodiment, a first group of sensor backend servers is configured to communicate with sensors deployed on resources in a first cloud computing environment deployed on a first cloud platform (e.g., AWS) and a second group of sensor backend servers is configured to communicate with sensors deployed on resources in a second cloud computing environment deployed on a second cloud platform (e.g., GCP).

A virtual machine 113 includes a sensor 310. In an embodiment, the sensor s10 is deployed as a service executed on the virtual machine 113. In some embodiments, a virtual machine 113 is configured to request binary code, a software package, and the like, for example, from a sensor backend 126, which when executed by the virtual machine 113 cause a sensor 310 to run as a service on the virtual machine 113. The sensor 310 is configured to listen to a data link layer communication, for example, through an eBPF interface.

A container cluster 210 runs a daemonset and includes a plurality of nodes, such as node 320. The daemonset ensures that each node 320 runs a daemonset pod 322, which is configured as a sensor. For example, a Kubernetes® cluster may execute a daemonset configured to deploy a daemonset pod on each deployed node, wherein the daemonset pod is configured to listen to a data link layer communication, for example through an eBPF interface, to communication of a plurality of pods, such as pod-1 324 through pod-N 326, where ‘N’ is an integer having a value of ‘1’ or greater. The daemonset pod 322 is configured, in an embodiment, to communicate with the sensor backend 126.

A serverless function 116 includes, in an embodiment, a function code 332, and a plurality of code layers 1 through M (labeled respectively as 334 through 336), where ‘M’ is an integer having a value of ‘1’ or greater. For example, in AWS Lambda a layer contains, in an embodiment, code, content, a combination thereof, and the like. In some embodiments, a layer, such as layer 334 includes runtime data, configuration data, software libraries, and the like.

In certain embodiments, the serverless function 116 includes a sensor layer 338. The sensor layer 338 is configured, in an embodiment, to listen to a data link layer communication of the serverless function 116, for example, through an eBPF interface.

The sensor service 310, daemonset pod 322, and sensor layer 338 are each an implementation of a sensor, according to an embodiment. In an embodiment, a sensor is configured to communicate with a sensor backend 126 through a transport layer protocol, such as TCP. For example, the sensor backend 126 is configured, in an embodiment, to listen to a predetermined port using a TCP protocol, and a sensor, such as sensor 310, daemonset pod 322, and sensor layer 338 are each configured to communicate with the sensor backend 126, for example by initiating communication using TCP over the predetermined port.

According to an embodiment, a sensor, such as sensor 210, sensor 232, and sensor 338, applies a policy, a rule, and the like, to validate an image, a code, an application, and the like, which is executed on a respective virtualization. For example, in an embodiment, a sensor is configured to detect an event that indicates that a code is executed, a software image is deployed, etc. In an embodiment, a sensor is configured to apply a rule, a definition, a detection, and the like, to a code, a software image, etc., to determine if, for example, the code is validated. In response to determining that the code is validated (or invalid), the sensor is further configured to communicate such information to the sensor backend server 126. In some embodiments, the sensor backend server 126 is configured to initiate inspection of a resource, a virtualization, and the like, in response to receiving an event from a sensor indicating that a code object, a software image, and the like, is deployed on the virtualization which requires validation.

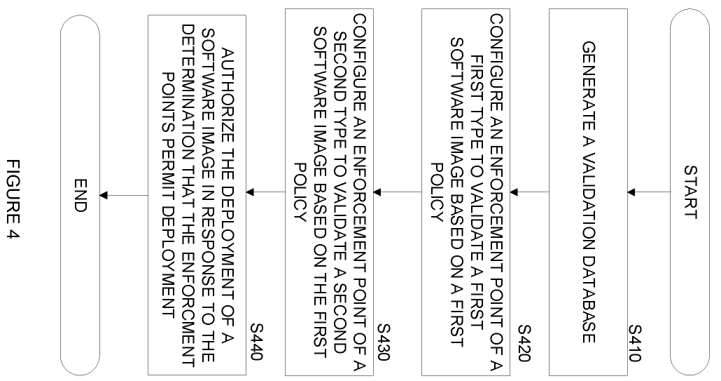

FIG. 4 is an example flowchart of a method for enforcing a cybersecurity policy through multiple enforcement points in a cloud computing environment, implemented in accordance with an embodiment. It is advantageous to utilize enforcement points for the enforcement of cybersecurity policies as it allows for a more centralized management of security policies across the computing environment. Further, it is advantageous to utilize enforcement points for the validation of software images to reduce potential security risks, vulnerabilities, and the like, associated with deploying a vulnerable software image, an un-validated software image, etc.

At S410, a validation database is initiated. In various embodiments, a software repository, a software image repository, a public code repository, and the like, is accessed for the detection of software images, software components, software applications, files, libraries, and the like. In an embodiment, the repository is configured to store software component identifiers, software applications, software images, and the like, associated with resources deployed in a computing environment. In an embodiment, the repository includes software images from known sources, third party vendors, third party suppliers, and the like.

In an embodiment, data from the repository is extracted to generate a validation database which includes a Software Bill of Materials (SBOM) of a computing environment. In an embodiment an SBOM is an inventory of the detected software components, software component identifiers, software images, software applications, files, libraries, binaries, software versions, and the like, of a computing environment.

In certain embodiments, the validation database is configured to store the SBOM based on a predetermined data schema, for example based on a JavaScript Object Notation (JSON) data schema, an eXtensible Markup Language (XML) data schema, and the like. In certain embodiments, the data schema is specified by a standard such as Software Package Data Exchange (SPDX), CycloneDX (CDX), and the like.

In various embodiments, software components, software images, software applications, and the like, from the SBOM are validated to verify authenticity and prevent potential security risks. In an embodiment, software images, software applications, software components, and the like, are validated based on a hash method. In an embodiment, an initial hash value (e.g., checksum) is generated for a software image, software application, software component, and the like, based on a hash function. In an embodiment, a hash function is a mathematical algorithm, mathematical operation, mathematical formula, etc. In some embodiments, a hash value is a unique fingerprint (e.g., unique identifier) of a software image, software component, and the like.

In an embodiment, an initial hash value for a software image is compared to a recalculated hash value generated when the software image is downloaded, transmitted, modified, etc., in order to verify the software image. For example, in an embodiment, an initial hash value based on SHA-3 is generated for a known software file shared by a vendor, and the initial hash value is compared to a recalculated hash value which is generated when the software file is downloaded. Since both the initial hash value and the recalculated hash value are the same, the software file is validated.

In an embodiment, the validation database is configured to store validation data including validation methods, initial hash values, recalculated has values, validation statuses for software images, software components, software applications, files, and the like.

At S420, an enforcement point of a first type is configured to validate a first software image based on a first policy. In certain embodiments, an enforcement point enforces access control policies for software images, software components, software applications, software processes, resources, and the like. In some embodiments, an enforcement point is configured to validate software images, software components, and the like, based on a predefined policy. In some embodiments, there are various types of enforcement points including an admission controller, a sensor, a disk, processes of the CI/CD pipeline, and the like.

In an embodiment an admission controller is an enforcement point of a first type and is configured to validate a software image based on a first predefined policy. In an embodiment, an admission controller is implemented in a software container cluster.

In various embodiments, an admission controller is implemented on a software container cluster of the cloud computing environment. In some embodiments, a software container cluster is implemented utilizing a Kubernetes® platform, a Docker® Engine, and the like. In certain embodiments, a software container cluster is configured to deploy a plurality of software containers. In an embodiment, a software container is a containerized software application.

In some embodiments, the admission controller is configured to intercept requests to modify a resource’s configuration, deploy a resource, provide access control, enforce a policy, and the like. In an embodiment, the admission controller is configured to validate a software image based on compliance with a predefined policy. For example, where an image is found to be non-compliant (i.e., not validated), the request to deploy the software container is denied.

In various embodiments, the admission controller is configured to request a predefined policy from a policy engine. The policy engine is configured to generate a policy, a rule, a conditional rule, and the like, for validating a software image, a software application, a resource, and the like.

For example, in an embodiment, the admission controller is configured to validate that the software image “nginx:1:24:06” is an approved entity based on a predefined list of approved entities generated from the policy engine. In an embodiment, for example, the admission controller is configured to validate that the software image “nginx:1.23.0” falls within a predefined approved software version list of “nginx:1.22.0” to “nginx:1.25.0”, generated from the policy engine. In an embodiment, tags which are associated with a software image are mutable, and proxy data, metadata, and the like, is validated across a software development lifecycle (SDLC) for an artifact such the software image.

At S430, an enforcement point of a second type is configured to validate a second software image based on the first policy. In an embodiment, the enforcement point of the first type and the enforcement point of the second type are both deployed in a computing environment, such as a cloud computing environment. In certain embodiments, an enforcement point enforces access control policies on software images, software components, resources, and the like, deployed in the cloud computing environment. In some embodiments, an enforcement point is configured to validate software images, software components, and the like, based on a predefined policy. In some embodiments, there are various types of enforcement points including a sensor, a disk, processes of a CI/CD pipeline, an admission controller, and the like.

In some embodiments, a sensor is configured to detect events indicating requests to deploy software images, software applications, software processes, software components, and the like, on a resource deployed in the cloud computing environment. In an embodiment, the sensor is configured to send an event, a record, etc., of each detected software process, software application, software component, and the like, to a sensor backend server.

In various embodiments, the sensor backend server is configured to receive a predefined policy generated from a policy engine, a unified policy engine, a detection engine, and the like. In an embodiment, the sensor backend server is configured to apply the predefined policy on an event related to a software image corresponding to the detected event, record, etc. In various embodiments, the sensor backend server is configured to apply the predefined policy on an event related to the software image, software application, software component, and the like, in order to validate them.

For example, in an embodiment, a predefined policy includes allowing the deployment of only a specific version of software, blocking all untrusted software images, allowing the deployment of only a specific list of software images, and the like.

In an embodiment, an inspector is configured to be utilized as an enforcement point. In some embodiments, an inspector is configured to store downloaded software images, software files, disk files, a combination thereof, and the like. In an embodiment, an inspectable disk stores hashes, checksums, and the like, associated with specific software images, software files, disk files, and the like. In an embodiment, the disk is an inspectable disk and is configured to be accessed by an inspector. In some embodiments, a software image, code object, and the like, is signed, for example, by generating a signature and associating the signature with the software image. In certain embodiments, associating a signature with an artifact (e.g., a software image, code object, etc.) includes generating a new file, artifact, etc., based on the existing artifact and the generated signature. In an embodiment, an inspector, a software container platform, and the like, are configured to detect a signature and determine validation and deployment based on the signature.

In an embodiment, the inspector is configured to inspect the inspectable disk for software images, software image hashes, checksums, and the like, in order to validate a software image. In certain embodiments, the inspector is configured to retrieve a hash or checksum, of a software image from the inspectable disk and determine if the retrieved hash or checksum value matches a predefined hash or checksum value associated with the software image. In certain embodiments, the inspector is configured to access a software application, a code object, a software image, and the like, on an inspectable disk, and generate a validation token, a hash value, a checksum, and the like, based on the accessed object.

For example, in an embodiment, the inspector is configured to generate a hash value based on a software image of “nginx-image” and compare it with a predetermined hash value for the same software image of “nginx-image”, for example, stored in a validation database.

In some embodiments, the processes of a CI/CD pipeline are configured to be utilized as an enforcement point. In certain embodiments, the CI/CD pipeline is an automated workflow that encompasses steps for continuous integration, continuous delivery, and deployment. In various embodiments, the CI/CD pipeline is a plurality of automated processes that streamline the software deployment process in the computing environment. In an embodiment, a process of the CI/CD pipeline is configured to deploy a software image, a software file, a software component, and the like, in a computing environment.

In some embodiments, a software process of the CI/CD pipeline is configured to generate an initial hash value for a generated software image, software file, software component, and the like. In some embodiments, initial hash values of generated software images are stored in a repository, local repository, public repository, validation database, and the like, of the computing environment.

In various embodiments, a recalculated hash value is generated in response to a software image undergoing a computing process (e.g., deployment of the software image). In some embodiments, a process of the CI/CD pipeline is configured to validate a software image, software component, and the like, based on comparing its initial hash value with its recalculated hash value. In an embodiment, software images are validated in order to verify that the software image is consistent after undergoing various software processes across different environments.

In certain embodiments, the software image is verified based on a predefined policy. For example, in an embodiment, a predefined policy includes blocking all unverified software images, allowing the deployment of only a specific version of a software image, allowing a specific list of software image identifiers, and the like.

At S440, the deployment of a software image is authorized. In an embodiment, the deployment of a software image is authorized in response to the determination that the enforcement point permits the deployment of the software image. In an embodiment, the deployment of a software image includes the provisioning of resources for the software image configuration and its deployment to various computing systems.

In an embodiment, an enforcement point is configured to authorize the deployment of a software image in response to the software image being validated. In an embodiment, an enforcement point includes a method of a CI/CD pipeline, a sensor, an admission controller, a disk, a combination thereof, and the like. For example, in an embodiment, in response to an enforcement point (e.g., method of a CI/CD pipeline), validating a software image based on the matching of its initial and recalculated hash values, the enforcement point will authorize the deployment of the software image in the cloud computing environment.

In some embodiments, an enforcement point is configured to authorize the deployment of a software image in response to validating the software image, software component, software application, and the like, based on a predefined policy. For example, in an embodiment, in response to the enforcement point validating a software image (e.g., “nginx_image:1:33”) based on meeting the predefined policy of being within a specific software version (e.g., version 1.30 to 1.40), the enforcement point is configured to authorize deployment of the software image.

In various embodiments, an enforcement point is configured to deny the deployment of a software image in response to the software image being not validated based on a policy, predefined policy, rule, conditional rule, and the like. For example, in an embodiment, in response to an initial hash value of a software image and if its recalculated hash value is determined to not match, the enforcement point is configured to not authorize the deployment of the software image.

Further, in an example embodiment, in response to a software image not being approved on a predefined policy list, the enforcement point is configured to deny the deployment of the software image in the cloud computing environment.

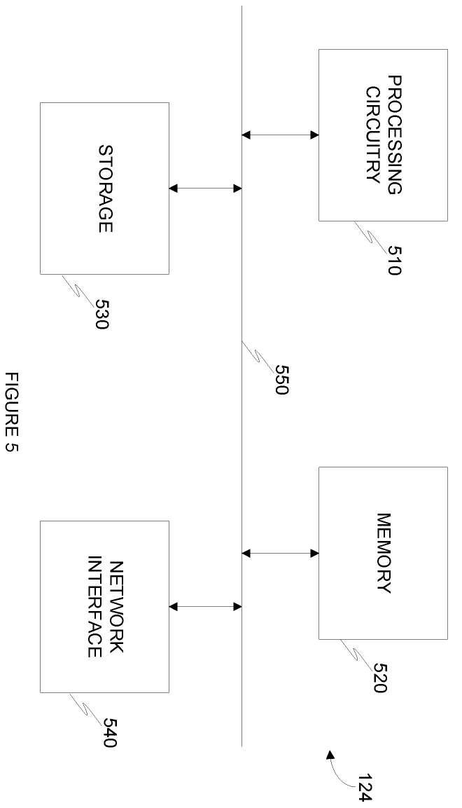

FIG. 5 is an example schematic diagram of an inspection controller 122 according to an embodiment. The inspection controller 122 includes a processing circuitry 510 coupled to a memory 520, a storage 530, and a network interface 540. In an embodiment, the components of the inspection controller 122 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof. In an embodiment, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein may be stored in the storage 530, in the memory 520, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 540 is configured to provide the inspection controller 122 with communication with, for example, the inspector 124, the sensor backend server 126, the security database 128, a combination thereof, and the like.

It should be understood that the embodiments described herein are not limited to the specific architecture illustrated in FIG. 5, and other architectures may be equally used without departing from the scope of the disclosed embodiments.

Furthermore, in certain embodiments the sensor backend server 126, the inspector 124, the validation database 119, a combination thereof, and the like, may be implemented with the architecture illustrated in FIG. 5. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for enforcing a cybersecurity policy through multiple different enforcement points in a cloud computing environment, comprising:
generating a validation database, the validation database including a plurality of validated software images and a corresponding method of validation;
configuring an enforcement point of a first type to validate a first deployable software image based on a first policy;
configuring an enforcement point of a second type to validate a second deployable software image based on the first policy; and
authorizing deployment of a software image in the cloud computing environment in response to determining that the enforcement points permit deployment.

2. The method of claim 1, further comprising:
accessing a plurality of software images in a repository, wherein a repository is configured to store software images.

3. The method of claim 1, further comprising:
configuring the validation database to store a software bill of materials (SBOM) based on a predetermined data schema.

4. The method of claim 1, further comprising:
validating the software image based on comparing an initial hash value associated with the software image to a recalculated hash value of the software image.

5. The method of claim 1, wherein a first type of enforcement point comprises:
an admission controller, wherein the admission controller is configured to request the first policy from a policy engine.

6. The method of claim 5 further comprising:
configuring the policy engine to generate any one of: a first policy, a policy, a predefined policy, a rule, a conditional rule, and any combination thereof.

7. The method of claim 1, wherein a second type of enforcement point includes any one of: a sensor, a process of a Continuous Integration and Continuous Deployment (CI/CD) pipeline, a disk, and any combination thereof.

8. The method of claim 7, further comprising:
configuring the sensor to detect events related to any one of: a software image, a software application, a software process, a software component, and any combination thereof, deployed in a resource on which the sensor is deployed.

9. The method of claim 1, further comprising:
configuring the enforcement point of the first type and the enforcement point of the second type to deny the deployment of the software image in response to the software image not being validated based on a policy.

10. A non-transitory computer-readable medium storing a set of instructions for enforcing a cybersecurity policy through multiple different enforcement points in a cloud computing environment, the set of instructions comprising:
one or more instructions that, when executed by one or more processors of a device, cause the device to:
generate a validation database, the validation database including a plurality of validated software images and a corresponding method of validation;
configure an enforcement point of a first type to validate a first deployable software image based on a first policy;
configure an enforcement point of a second type to validate a second deployable software image based on the first policy; and
authorize deployment of a software image in the cloud computing environment in response to determining that the enforcement points permit deployment.

11. A system for enforcing a cybersecurity policy through multiple different enforcement points in a cloud computing environment comprising:
a processing circuitry;
a memory, the memory containing instructions that, when executed by the processing circuitry, configure the system to:
generate a validation database, the validation database including a plurality of validated software images and a corresponding method of validation;
configure an enforcement point of a first type to validate a first deployable software image based on a first policy;
configure an enforcement point of a second type to validate a second deployable software image based on the first policy; and
authorize deployment of a software image in the cloud computing environment in response to determining that the enforcement points permit deployment.

12. The system of claim 11, wherein the memory contains further instructions which when executed by the processing circuitry further configure the system to:
access a plurality of software images in a repository, wherein a repository is configured to store software images.

13. The system of claim 11, wherein the memory contains further instructions which when executed by the processing circuitry further configure the system to:
configure the validation database to store a software bill of materials (SBOM) based on a predetermined data schema.

14. The system of claim 11, wherein the memory contains further instructions which when executed by the processing circuitry further configure the system to:
validate the software image based on comparing an initial hash value associated with the software image to a recalculated hash value of the software image.

15. The system of claim 11, wherein a first type of enforcement point comprises:
an admission controller, wherein the admission controller is configured to request the first policy from a policy engine.

16. The system of claim 15, wherein the memory contains further instructions which when executed by the processing circuitry further configure the system to:
configure the policy engine to generate any one of: a first policy, a policy, a predefined policy, a rule, a conditional rule, and any combination thereof.

17. The system of claim 11, wherein a second type of enforcement point includes any one of:
a sensor, a process of a Continuous Integration and Continuous Deployment (CI/CD) pipeline, a disk, and any combination thereof.

18. The system of claim 17, wherein the memory contains further instructions which when executed by the processing circuitry further configure the system to:
configure the sensor to detect events related to any one of: a software image, a software application, a software process, a software component, and any combination thereof, deployed in a resource on which the sensor is deployed.

19. The system of claim 11, wherein the memory contains further instructions which when executed by the processing circuitry further configure the system to:
configure the enforcement point of the first type and the enforcement point of the second type to deny the deployment of the software image in response to the software image not being validated based on a policy.
